(19) United States
(12) Patent Application Publication
(10) Pub. No.: US 2022/0198343 A1
(43) Pub. Date: Jun. 23, 2022

(54) INFORMATION PROPOSING DEVICE AND INFORMATION PROPOSING METHOD

(71) Applicant: JVCKENWOOD Corporation, Yokohama-shi (JP)

(72) Inventors: Yuka Ito, Yokohama-shi (JP); Ryotaro Futamura, Yokohama-shi (JP); Kohei Ohashi, Yokohama-shi (JP); Risa Sonobe, Yokohama-shi (JP); Kotomi Mochizuki, Yokohama-shi (JP)

(21) Appl. No.: 17/523,952

(22) Filed: Nov. 11, 2021

(30) Foreign Application Priority Data
Dec. 22, 2020 (JP) 2020-212723

(51) Int. Cl. G06Q 10/02; G06Q 50/30

(52) U.S. Cl. CPC G06Q 10/02; G06Q 50/30

(57) ABSTRACT

An information proposing device includes: an obtaining unit that obtains service provider information including information related to a service that a service provider is able to provide, and condition information related to a condition for a service that a user desires to receive; and a calculating unit that calculates information related to the service provider and the service to be selected by the user on the basis of a result of the matching processing.

### CROSS-REFERENCE TO RELATED APPLICATIONS

This application claims priority from Japanese Application No. 2020-212723, filed on Dec. 22, 2020, the contents of which are incorporated by reference herein in its entirety.

### BACKGROUND

### 1. Technical Field

The present invention relates to information proposing devices and information proposing methods.

### 2. Description of the Related Art

Techniques enabling a user to automatically select an agreeable person to share a ride with the user have been disclosed thus far for the user to make a reservation for a share-ride taxi at a tourist site (for example, see Japanese Laid-open Patent Publication No. 2005-18697).

Some areas in local regions visited for sightseeing have less means of transportation. Provision of Mobility as a Service (Maas) taking advantage of resources of local regions and their residents to tourists by the residents in the areas at the sightseeing destinations has thus been proposed. However, services that the residents are able to provide may be different from services that the tourists want to receive. Therefore, matching processing between the services that the residents in the areas are able to provide and the services that the tourists wish to receive is desirably performed.

### SUMMARY

It is an object of the present invention to at least partially solve the problems in the conventional technology.

An information proposing device according to the present disclosure, includes an obtaining unit that obtains: service provider information including information related to a service that a service provider is able to provide, and condition information related to a condition for a service that a user desires to receive; a processing unit that performs matching processing between the condition information and the service provider information, and a calculating unit that calculates information related to the service provider and the service that are to be selected by the user, on the basis of a result of the matching processing.

An information proposing method according to the present disclosure, includes a step of obtaining: service provider information including information related to a service that a service provider is able to provide, and condition information related to a condition for a service that a user desires to receive, a step of performing matching processing between the condition information and the service provider information, and a step of calculating information related to the service provider and the service that are to be selected by the user, on the basis of a result of the matching processing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a configuration of an information proposing system according to a first embodiment;

FIG. 2 is a block diagram illustrating an example of a configuration of an information proposing device according to the first embodiment;

FIG. 3 is a flowchart illustrating an example of a flow of storage processing according to the first embodiment;

FIG. 4 is a diagram for explanation of service provider information according to the first embodiment;

FIG. 5 is a flowchart illustrating an example of a flow of calculation processing according to the first embodiment;

FIG. 6 is a diagram for explanation of condition information according to the first embodiment;

FIG. 7 is a diagram for explanation of matching processing according to the first embodiment;

FIG. 8 is a diagram for explanation of an example of presented information;

FIG. 9 is a block diagram illustrating an example of a configuration of an information proposing device according to a second embodiment;

FIG. 10 is a flowchart illustrating an example of a flow of calculation processing according to the second embodiment;

FIG. 11 is a diagram for explanation of a method of generating plural experience plans, according to the second embodiment;

FIG. 12 is a block diagram illustrating an example of a configuration of an information proposing device according to a third embodiment;

FIG. 13 is a flowchart illustrating an example of a flow of a process of calculating a skill of a service provider, according to the third embodiment;

FIG. 14 is a block diagram illustrating an example of a configuration of an information proposing device according to a fourth embodiment;

FIG. 15 is a flowchart illustrating an example of a flow of a process of calculating a skill of a service provider, according to the fourth embodiment; and

FIG. 16 is a block diagram illustrating an example of a configuration of an information proposing device according to a fifth embodiment.

### DETAILED DESCRIPTION OF THE PREFERRED EMBODIMENTS

Embodiments of the present invention will hereinafter be described in detail, on the basis of the drawings. The present invention is not limited by the embodiments described below.

### First Embodiment

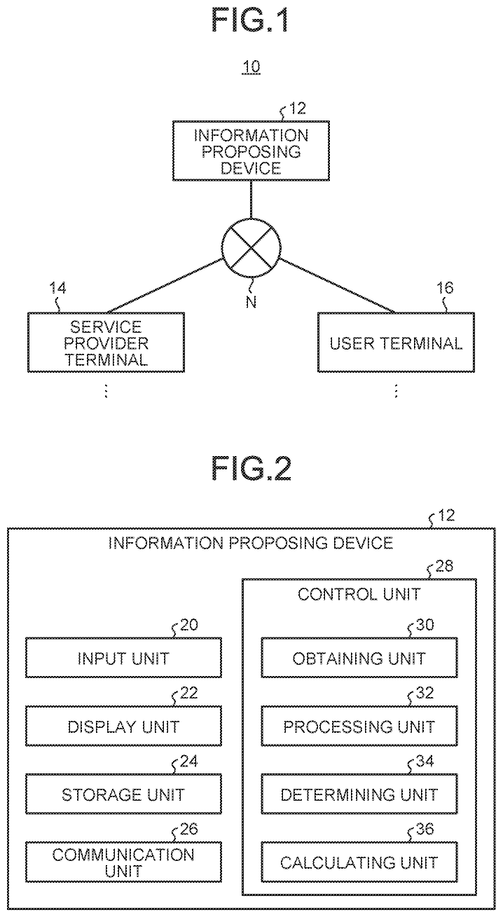

An information proposing system according to a first embodiment will be described using FIG. 1. FIG. 1 is a diagram illustrating an example of a configuration of the information proposing system according to the first embodiment.

As illustrated in FIG. 1, an information proposing system 10 includes an information proposing device 12, plural service provider terminals 14, and plural user terminals 16. The information proposing device 12 and the plural service provider terminals 14 are connected to enable communication with each other via a network N. The information proposing device 12 and the plural user terminals 16 are connected to enable communication with each other via the network N. The information proposing system 10 is a system that performs matching processing between: condition information related to a condition for a service desired by a tourist for a tourist site; and service provider information related to a service that a service providing company for a tourist site is able to provide. On the basis of a result of the matching processing, the information proposing system 10 presents a service provider and service details that match the condition, to the tourist.

The service provider terminals 14 are each a terminal device used by a service provider who provides a service at a tourist site, for example. For example, a service provider provides various means of transportation for a tourist site to tourists. A service provider picks up and drops off a tourist, for example, by driving a vehicle, such as a privately owned car or a small truck. A service provider may be, for example, a resident residing at a tourist site, for example. A service provider inputs service provider information including information on means of transportation that are able to be provided to tourists, for example, to a service provider terminal 14. The service provider terminals 14 may be, for example, any of smartphones, tablet terminals, and personal computers, but are not limited to these examples. A service provider terminal 14 may be any other communication device.

A service provider inputs service provider information including, for example, information related to schedules, assets, means of transportation, skills, and depth of communication that is able to be provided to tourists, to a service provider terminal 14.

The information related to schedules may include information related to hourly, daily, weekly, and monthly schedules of the service provider.

The information related to assets includes information related to assets of the service provider. The assets may be a house and land, but are not limited to these examples.

The information related to means of transportation may include information related to means of transportation owned by the service provider. The means of transportation are, for example, an ordinary motor vehicle, a motorcycle that is able to be ridden in tandem by two people, and a small truck. For example, if the service provider does farming, for example, the means of transportation may include a tractor. If the service provider is engaged in fishery, for example, the means of transportation may include a fishing boat.

The information related to skills may include information related to various kinds of knowledge and skills that the service provider has. The information related to skills may include, for example, information on experiences that the service provider is able to provide to tourists. Specifically, the information related to skills may include information indicating that the service provider is capable of letting tourists experience farming or fishing. The information related to skills may include information indicating that the service provider is good at cooking and is able to provide dishes using local specialties.

The information related to communication includes information related to depth of communication that is able to be provided to tourists. For example, the information related to communication may include information related to assets owned by the service provider. For example, if the service provider owns any house or facilities where tourists are able to stay, or any land, for example, the information related to communication includes information indicating that the service provider is capable of letting tourists stay at the house or facilities or information indicating that an event using the land will be held. The information related to communication may also be called deepness information.

The information related to assets, the information related to means of transportation, and the information related to skills may also be called resource information according to this embodiment.

A service provider terminal 14 transmits service provider information received from a service provider to the information proposing device 12 via the network N. The service provider may directly input the service provider information to the information proposing device 12.

The user terminals 16 are each a terminal device to be used by a user, such as a tourist. A user inputs condition information related to conditions for a service that the user desires to receive from a service provider, to a user terminal 16. The user terminal 16 transmits the condition information received from the user, such as a tourist, to the information proposing device 12 via the network N.

The information proposing device 12 obtains service provider information related to a service provider who provides a service, from a service provider terminal 14. The information proposing device 12 obtains, from a user terminal 16, condition information related to conditions for a service that a user desires to receive from a service provider. The information proposing device 12 calculates any service provider and service details to be selected by the user by performing matching processing between the service provider information and the condition information. The service provider and service details calculated by the information proposing device 12 are presented by the user terminal 16 used by the user.

### Information Proposing Device

An example of a configuration of an information proposing device according to the first embodiment will be described using FIG. 2. FIG. 2 is a block diagram illustrating the example of the configuration of the information proposing device according to the first embodiment.

As illustrated in FIG. 2, the information proposing device 12 includes an input unit 20, a display unit 22, a storage unit 24, a communication unit 26, and a control unit 28.

The input unit 20 is an input device that receives various operations on the information proposing device 12. The input unit 20 may be implemented by, for example, a mouse and a keyboard, a touch panel, buttons, or switches.

The display unit 22 displays various kinds of information. The display unit 22 is, for example, a display, such as a liquid crystal display (LCD) or an organic electro-luminescence (EL) display.

The storage unit 24 is a memory that stores therein various kinds of information, such as contents of arithmetic operations by the control unit 28 and programs, and includes, for example, at least one of: a random access memory (RAM); a main storage, such as a read only memory (ROM); and an external storage, such as a hard disk drive (HDD).

The communication unit 26 carries out communication between the information proposing device 12 and an external device. The communication unit 26 performs communication between the information proposing device 12 and a service provider terminal 14, for example. The communication unit 26 performs communication between the information proposing device 12 and a user terminal 16, for example.

The control unit 28 controls operation of each unit of the information proposing device 12. The control unit 28 is implemented, for example, by a central processing unit (CPU) or a micro-processing unit (MPU) executing a program stored in the storage unit 24, with a RAM serving as a work area. The control unit 28 may be implemented by an integrated circuit, such as an application specific integrated circuit (ASIC) or a field programmable gate array (FPGA), for example. The control unit 28 may be implemented by a combination of hardware and software.

The control unit 28 includes an obtaining unit 30, a processing unit 32, a determining unit 34, and a calculating unit 36.

The obtaining unit 30 obtains various kinds of information. The obtaining unit 30 obtains, for example, service provider information related to a service provider, from a service provider terminal 14. The obtaining unit 30 obtains, for example, condition information related to conditions for a service that a user desires to receive, from a user terminal 16. The obtaining unit 30 stores the service provider information obtained from the service provider terminal 14, into the storage unit 24.

The processing unit 32 performs processing of various kinds of information. The processing unit 32 performs matching processing between service provider information and condition information. The processing unit 32 performs, for example, matching processing between pieces of information, such as schedules and resources in both service provider information and condition information, and extracts any service provider that matches the condition information. For example, the processing unit 32 performs matching processing between service provider information and condition information by, for example, calculating similarity between the service provider information and the condition information.

The processing unit 32 may calculate information related to depth of communication by a service provider, on the basis of service provider information, for example. The depth of communication may also be called deepness. On the basis of any service and experience that the service provider is able to provide to tourists, for example, the processing unit 32 calculates the deepness. For example, the processing unit 32 may calculate the deepness as any one of, in ascending order, “transportation”, “hospitality” (“Omotenashi”, in Japanese), “guidance”, “experience”, and “accommodation”. On the basis of word-of-mouth information from a social network service (SNS), for example, the processing unit 32 may calculate the deepness. The processing unit 32 may calculate deepness only for any service provider extracted on the basis of information on schedules and resources, for example.

The determining unit 34 determines various kinds of information. The determining unit 34 determines service provider information matching condition information, on the basis of a result of matching processing and a result of calculation of deepness by the processing unit 32, for example. Specifically, the determining unit 34 performs matching processing between deepness for a service provider extracted by the processing unit 32 and deepness included in condition information, for example.

The calculating unit 36 calculates various kinds of information. On the basis of a result of determination by the determining unit 34, the calculating unit 36 calculates information to be presented to a user terminal 16, for example. The calculating unit 36 calculates, on the basis of a result of determination by the determining unit 34, a service provider and service details that match condition information, for example.

### Storage Processing

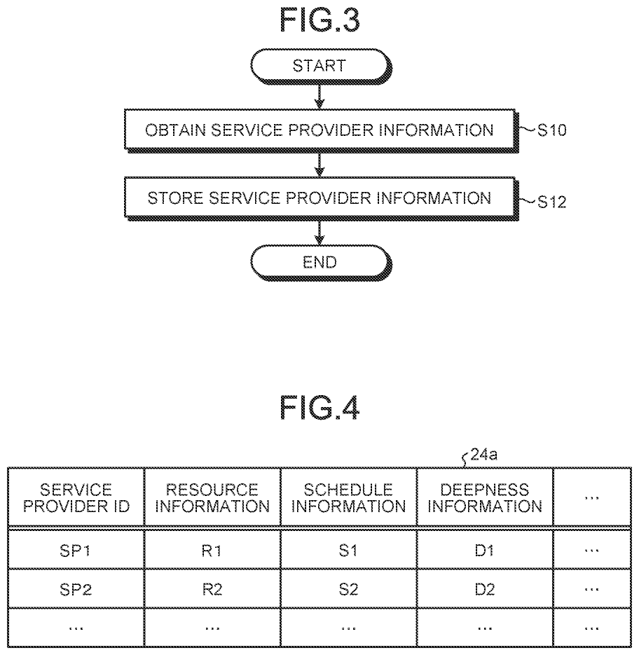

Storage processing of service provider information according to the first embodiment will be described using FIG. 3. FIG. 3 is a flowchart illustrating an example of a flow of the storage processing according to the first embodiment.

Firstly, the control unit 28 obtains service provider information from the service provider terminals 14 (Step S10). Specifically, the obtaining unit 30 obtains, from the service provider terminals 14 of the service providers, service provider information including information related to schedules, means of transportation, and skills of the service providers, and depth of communication that is able to be provided by the service providers to tourists. The flow then proceeds to Step S12.

The control unit 28 stores the service provider information obtained from the service provider terminals 14, into the storage unit 24 (Step S12). Specifically, the obtaining unit 30 obtains the service provider information from the service provider terminals 14 of the service providers and stores the obtained service provider information on the service providers, into the storage unit 24.

Service provider information according to the first embodiment will be described using FIG. 4. FIG. 4 is a diagram for explanation of the service provider information according to the first embodiment.

FIG. 4 illustrates service provider information 24a stored in the storage unit 24. The service provider information 24a may include items, such as “service provider ID”, “resource information”, “schedule information”, and “deepness information”, for example.

“Service provider ID” indicates identification information for individually identifying the service providers. “Service provider ID” has identification information for identifying the service providers, for example, a service provider ID, “SP1”, and a service provider ID, “SP2”. In the example illustrated in FIG. 4, “service provider ID” indicates conceptual information like the service provider ID, “SP1”, and the service provider ID, “SP2”, but in practice, “service provider ID” indicates specific information, such as names, age, and sex of the service providers. “Service provider ID” may include information, such as photographs of faces of the service providers.

“Resource information” indicates information related to resources that are able to be provided by the service providers to tourists (users). “Resource information” has information related to resources, such as resource information, “R1”, and resource information, “R2”. The resource information, “R1”, indicates information related to any resource of the service provider having the service provider ID, “SP1”. The resource information, “R2”, indicates information related to any resource of the service provider having the service provider ID, “SP2”. In the example illustrated in FIG. 3, “resource information” indicates conceptual information like the resource information, “R1”, and the resource information, “R2”, but in practice, “resource information” may include information related to assets, such as means of transportation, skills, houses, and land, that are owned by the service providers.

The information related to means of transportation may include information indicating that tourists are able to be guided around recommended spots by car and by foot, for example. For example, the information related to means of transportation may include information indicating that a farmer who is a service provider is capable of picking up and dropping off tourists by driving the farmer's own small truck.

The information related to skills may include information indicating that the service provider is a farmer and good at cooking. In other words, the information related to skills may include information indicating that the service provider is capable of letting tourists experience farming and providing dishes using local specialties.

The information related to assets may include information indicating that tourists are able to stay at the service provider's house.

“Schedule information” indicates information related to schedules of the service providers. “Schedule information” has information related to schedules, such as schedule information, “S1”, and schedule information, “S2”. The schedule information, “S1”, indicates information related to schedules of the service provider having the service provider ID, “SP1”. The schedule information, “S2, indicates information related to schedules of the service provider having the service provider ID, “SP2”. In the example illustrated in FIG. 3, “schedule information” indicates conceptual information, like the schedule information, “S1”, and the schedule information, “S2”, but in practice, “schedule information” may include weekly or monthly schedules of the service providers. The weekly or monthly schedules may include information related to the dates and times on and at which services are able to be provided to tourists. The weekly or monthly schedules may include information related to the dates and times when tourists are able to be picked up and dropped off by a small truck, the dates and times when tourists are able to experience the harvest of crops, and the date and times when the service providers are able to walk, together with tourists, around spots recommended by the service providers.

“Deepness information” indicates information related to the depth (deepness) of involvement with tourists, for example. “Deepness information” has information related to the depth of involvement with tourists, like deepness information, “D1”, and deepness information, “D2”. The deepness information, “D1”, indicates information related to the deepness for the service provider having the service provider ID, “SP1”. The deepness information, “D2”, indicates information related to the deepness for the service provider having the service provider ID, “SP2”. In the example illustrated in FIG. 3, “deepness information” indicates conceptual information, like the deepness information, “D1”, and the deepness information, “D2”, but in practice, “deepness information” indicates information related to the depth of involvement that is able to be provided to tourists.

That is, “resource information”, “schedule information”, and “deepness information” have been associated with “service provider ID”. Information that has been associated with “service provider ID” is not limited to these pieces of information, and any other pieces of information may be associated with “service provider ID”. For example, the number of times a stopover has been made and the stopover time period at each of the areas and facilities at a tourist site may be associated with “service provider ID”. Information, such as “regional skill information” and “communication skill information”, which will be described later, may be associated with “service provider ID”.

### Calculation Processing

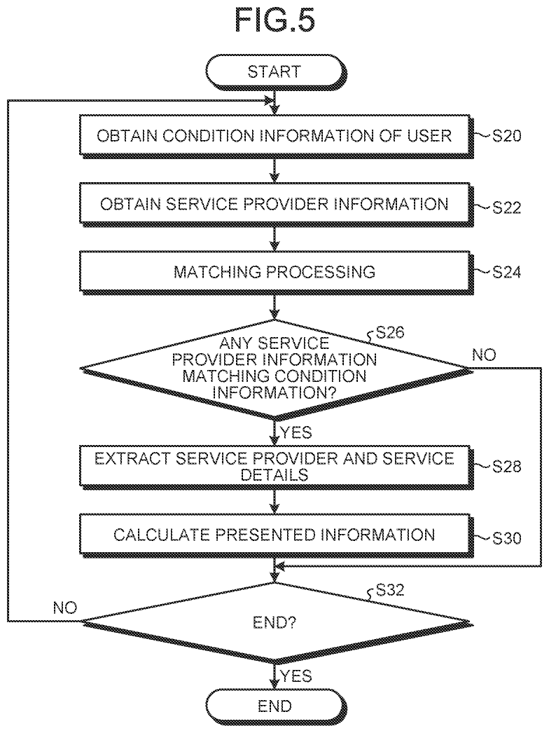

Calculation processing according to the first embodiment will be described using FIG. 5. FIG. 5 is a flowchart illustrating an example of a flow of the calculation processing according to the first embodiment.

Firstly, the control unit 28 obtains condition information for a service desired by a user who is a tourist (Step S20). Specifically, the obtaining unit 30 obtains condition information from a user terminal 16, via the communication unit 26. The flow then proceeds to Step S22.

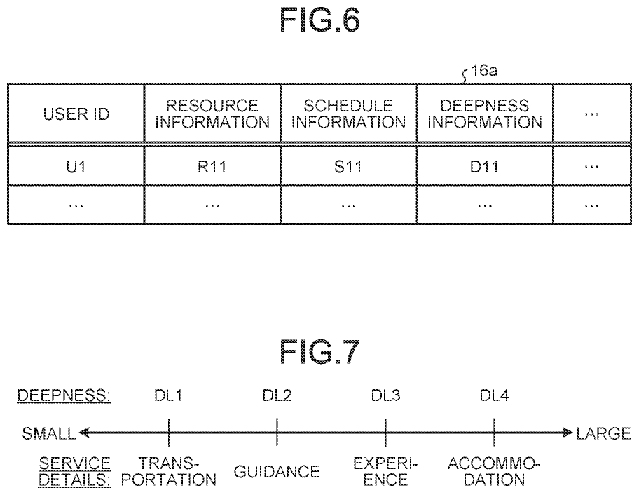

Condition information according to the first embodiment will be described using FIG. 6. FIG. 6 is a diagram for explanation of the condition information according to the first embodiment.

FIG. 6 illustrates condition information 16a obtained from a user terminal 16. The condition information 16a may include items, such as “user ID”, “resource information”, “schedule information”, and “deepness information”, for example.

“User ID” indicates identification information for individually identifying users who are tourists. “User ID” has, for example, identification information for identifying users, such as a user ID, “U1”. In the example illustrated in FIG. 6, “user ID” indicates conceptual information, like the user ID, “U1”, but in practice, “user ID” indicates specific information, like names of the users.

“Resource information” indicates information related to provision of resources that users desire to receive at sightseeing destinations. “Resource information” has information related to resources, such as resource information, “R11”. In the example illustrated in FIG. 6, “resource information” indicates conceptual information, like the resource information, “R11”, but in practice, “resource information” indicates information related to resources that the users desire to receive. For example, “resource information” indicates information, such as “regular passenger car” that is a means of transportation.

“Deepness information” includes information related to the depth of involvement with the service providers at sightseeing destinations. “Deepness information” has information related to the depth of involvement with service providers, such as deepness information, “D11”. In the example illustrated in FIG. 6, “deepness information” indicates conceptual information, like the deepness information, “D11”, but in practice, “deepness information” indicates specific information that is desired to be received from the service providers.

That is, “resource information”, “schedule information”, and “deepness information” have been associated with “user ID”. Information that has been associated with “user ID” is not limited to these pieces of information, and any other pieces of information may be associated with “user ID”. Information, such as “regional skill information” and “communication skill information”, which will be described later, may be associated with “user ID”.

The control unit 28 obtains service provider information (Step S22). Specifically, the obtaining unit 30 obtains service provider information stored in the storage unit 24. The flow then proceeds to Step S24.

The control unit 28 performs matching processing (Step S24). Specifically, the processing unit 32 performs matching processing by calculating similarity between the condition information obtained at Step S20 and the service provider information obtained at Step S22. More specifically, the processing unit 32 performs matching processing for “resource information” and “schedule information”, of the information included in the condition information and service provider information. The flow then proceeds to Step S26.

The control unit 28 determines whether or not any service provider information matching the condition information is available (Step S26). Specifically, the determining unit 34 performs matching processing on the basis of “deepness information”, for example, of the information included in the condition information and service provider information, and determines that service provider information including deepness information having similarity of a predetermined value or larger is service provider information matching the condition information.

A method of determining similarity of deepness according to the embodiment will be described using FIG. 7. FIG. 7 is a diagram for explanation of the method of determining similarity of deepness according to the embodiment.

As illustrated in FIG. 7, in this embodiment, for example, levels of deepness have been associated with details of services that are able to be provided. Service details having a deepness level, “DL1”, correspond to, for example, “transportation”. Service details having a deepness level, “DL2”, correspond to, for example, “guidance”. Service details having a deepness level, “DL3”, correspond to, for example, “experience”. Service details having a deepness level, “DL4”, correspond to, for example, “accommodation”.

The determining unit 34 determines that service details having close deepness levels are similar, for example. In a case where deepness information included in condition information is “guidance” of the deepness level, “DL2”, for example, the determining unit 34 determines that the similarity between the condition information and service provider information has a predetermined value or larger if “transportation” of the deepness level, “DL1” and “experience” of the deepness level, “DL3”, are included in the service provider information. That is, the determining unit 34 determines that any service provider having service provider information including any of “transportation” of the deepness level, DL1″, “guidance” of the deepness level, “DL2”, and “experience” of the deepness level, “DL3”, is matching, for example. In this case, the determining unit 34 determines that service provider information matching the condition information is available.

The determining unit 34 may determine that service provider information matching condition information is available if the deepness in the condition information and the deepness in the service provider information match each other. For example, in a case where the deepness in condition information is “guidance” of the deepness level, “DL2”, the determining unit 34 may determine that service provider information matching the condition information is available if the deepness in the service provider information is “guidance” of the deepness level, “DL2”.

The determining unit 34 may determine that service provider information matching condition information is available if the deepness in the service provider information is equal to or larger than the deepness in the condition information. For example, in a case where the deepness in condition information is “guidance” of the deepness level, “DL2”, the determining unit 34 may determine that service provider information matching the condition information is available if the deepness in the service provider information is “guidance” of the deepness level, “DL2”, or “experience” of the deepness level, “DL3”.

If it has been determined that service provider information matching the condition information is available (Step S26; Yes), the flow proceeds to Step S28. If it has been determined that no service provider information matching the condition information is available (Step S26; No), the flow proceeds to Step S32.

The control unit 28 extracts a service provider and service details (Step S28). Specifically, the determining unit 34 extracts any service provider and service details that match condition information. The flow then proceeds to Step S30.

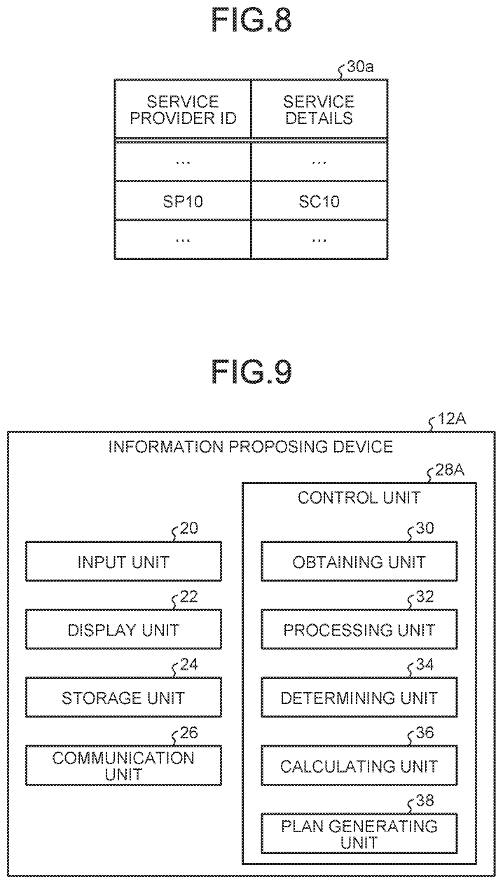

The control unit 28 calculates presented information including service provider information and service details (Step S30). Specifically, the calculating unit 36 calculates presented information to be displayed by a user terminal 16. FIG. 8 is a diagram for explanation of an example of the presented information. As illustrated in FIG. 8, presented information 30a includes items, “service provider ID” and “service details”. “Service provider ID” and “service details” have been associated with each other. In the example illustrated in FIG. 8, the calculating unit 36 presents, for example, a service provider having a service provider ID, “SP10”, and service details, “SC10”, that have been associated with the service provider ID, “SP10”. In the example illustrated in FIG. 8, “service details” indicates conceptual information, like the service details, “SC10”, but in practice, “service details” indicates specific service details. “Service details” includes information on times and services that users are able to experience, for example. Specifically, “service details” may be “transportation to hostel by small truck at 10 o'clock”, “farming experience in field”, and “stroll around recommended spots by guidance of service provider”, for example.

The control unit 28 determines whether or not processing is to be ended (Step S32). Specifically, if presented information has been selected by a user, such as a tourist, using a user terminal 16, or if an operation to end processing has been received, the control unit 28 determines that processing is to be ended. If it has been determined that processing is to be ended (Step S32; Yes), the processing of FIG. 5 is ended. If it has been determined that processing is not to be ended (Step S32; No), the flow proceeds to Step S20.

As described above, in the first embodiment, matching processing between service provider information on service providers and condition information of a tourist, for example, is performed. In the first embodiment, any service provider and service details that match the condition information are calculated on the basis of a result of the matching processing. The first embodiment thereby enables presentation of appropriate service providers and service details to tourists.

### Second Embodiment

An example of a configuration of an information proposing device according to a second embodiment will be described using FIG. 9. FIG. 9 is a block diagram illustrating the example of the configuration of the information proposing device according to the second embodiment.

As illustrated in FIG. 9, an information proposing device 12A is different from the information proposing device 12 illustrated in FIG. 9 in that the information proposing device 12A has a control unit 28A that includes a plan generating unit 38.

The plan generating unit 38 generates at least one experience plan to be provided by a service provider to a tourist, for example. For example, the plan generating unit 38 generates a plan on the basis of service provider information on a service provider and condition information input by a tourist. The plan generating unit 38 generates a plan according to deepness. In this second embodiment, the condition information input by the tourist may include information related to a time, a starting point, and a destination.

### Calculation Processing

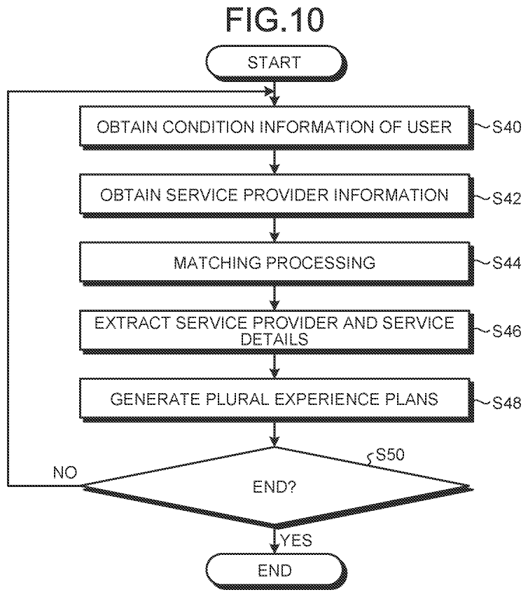

Calculation processing according to the second embodiment will be described using FIG. 10. FIG. 10 is a flowchart illustrating an example of a flow of the calculation processing according to the second embodiment.

The control unit 28A obtains condition information of a user, such as a tourist (Step S40). Specifically, the obtaining unit 30 obtains condition information including information related to desired time and destination from a user terminal 16. For example, the obtaining unit 30 obtains the condition information 16a illustrated in FIG. 6. In a case where a tourist has input information on preference and/or experiences desired into a user terminal 16, for example, the obtaining unit 30 may obtain the information on preference and/or experiences desired input by the tourist. The flow then proceeds to Step S42.

Processing at Step S42, Step S44, and Step S46 is respectively the same as the processing at Step S22, Step S24, and Step S26 illustrated in FIG. 5 and description thereof will thus be omitted.

After Step S46, the control unit 28A generates plural experience plans (Step S48). Specifically, the plan generating unit 38 generates plural experience plans on the basis of the service provider and service details that have been extracted at Step S46.

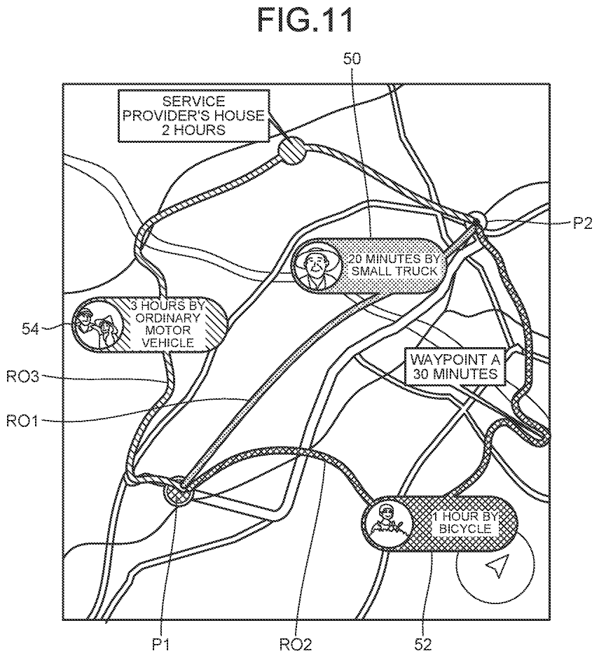

A method of generating plural experience plans according to the second embodiment will be described using FIG. 11. FIG. 11 is a diagram for explanation of the method of generating plural experience plans according to the second embodiment.

The following description using FIG. 11 is on a process of generating plural plans in a case where transportation from a starting point P1 to a destination point P2 is provided by means of transportation of service providers. As illustrated in FIG. 9, according to the deepness of service providers, the plan generating unit 38 generates “straight course” by which transportation is provided through a route RO1, “side trip course” by which transportation is provided through a route RO2, and “hospitality course” by which transportation is provided through a route RO3.

“Straight course” is the shortest route from the starting point P1 to the destination point P2. Service provider information 50 including various kinds of information on a service provider of “straight course” is displayed on the route RO1. For example, the service provider information 50 includes a photograph of the face of the service provider, and information on a schedule, the means of transportation, and the required time period. The service provider information 50 in FIG. 9 indicates, together with a photograph of the face of the service provider, that the means of transportation is a small truck and the required time period is 20 minutes. Because transportation is provided to the destination point P2 through the shortest route for “straight course”, the processing unit 32 does not need to perform matching processing for the deepness of the service provider. In other words, the service provider may be extracted by matching processing with conditions excluding the deepness. In this embodiment, the service provider is preferably caused to recognize that the course is “straight course”.

“Side trip course” is a route by which transportation is provided from the starting point P1 to the destination point P2 via a side trip point, such as a location recommended by the service provider. The calculating unit 36 may calculate information including a schedule of the service provider who is able to be selected, the means of transportation, the route via the side trip point, and the required time period. Service provider information 52 in FIG. 11 includes a photograph of the face of the service provider, and information on the schedule, the means of transportation, and the required time period. The service provider information 52 in FIG. 11 indicates, together with the photograph of the face of the service provider, that the means of transportation are bicycles and the required time period is one hour. The side trip point on the route RO2 has information displayed thereon, the information indicating that the tourist will pass through a tourist site, Waypoint A, while being guided by the service provider. The calculating unit 36 may calculate information enabling the user terminal 16 to display suggestions on areas and facilities that are known well by the matching service provider. For example, the calculating unit 36 may calculate information that enables the user terminal 16 to display suggestions on areas and facilities corresponding to preference input by the tourist, of the areas and facilities that are known well by the service provider. For “side trip course”, the processing unit 32 may extract, by matching, a service provider having deepness of a predetermined level or higher. For “side trip course”, the tourist may input preference information on history and food or a desired waypoint to stop over and the calculating unit 36 may calculate a matching service provider on the basis of skill information related to the preference information or the desired waypoint.

“Hospitality course” is a route by which the tourist is able to receive hospitality by going to a restaurant with the service provider or having an experience at the house of the service provider, while traveling from the starting point P1 to the destination point P2. For example, “hospitality” means that the service provider and the tourist spend a predetermined amount of time together at the same location, or that the service provider and the tourist share the same experience. Service provider information 54 in FIG. 9 indicates, together with a photograph of the face of the service provider, that the means of transportation is an ordinary motor vehicle and the required time period is three hours. Information indicating that the stay at the house of the service provider lasts for two hours is displayed at the side trip point on the route RO3. The calculating unit 36 may display suggestions on areas and facilities that are known well by the matching service provider. The plan generating unit 38 may display a service that is able to be provided by the service provider, the route, and the required time period. For “hospitality course”, the processing unit 32 may extract, by matching, a service provider having deepness of a predetermined level or higher. Furthermore, for “hospitality course”, the tourist may input preference information on history and food or a desired experience (activity) and the calculating unit 36 may calculate a matching service provider on the basis of skill information related to the preference information or desired experience.

After Step S48, the control unit 28A determines whether processing is to be ended (Step S50). Specifically, if an experience plan has been selected by a user, such as a tourist, using a user terminal 16, or if an operation to end processing has been received, the control unit 28A determines that processing is to be ended. If it has been determined that processing is to be ended (Step S50; Yes), the processing of FIG. 5 is ended. If it is determined that processing is not to be ended (Step S50; No), the flow proceeds to Step S40.

As described above, in this second embodiment, matching processing between condition information of a tourist and service provider information on service providers is performed, and plural experience plans are generated on the basis of a result of the matching processing. In this second embodiment, the plural experience plans generated are presented to the tourist. The tourist is able to select a desired experience plan from the experience plans generated. The second embodiment thereby enables appropriate selection of desired experience plans at tourist sites.

### Third Embodiment

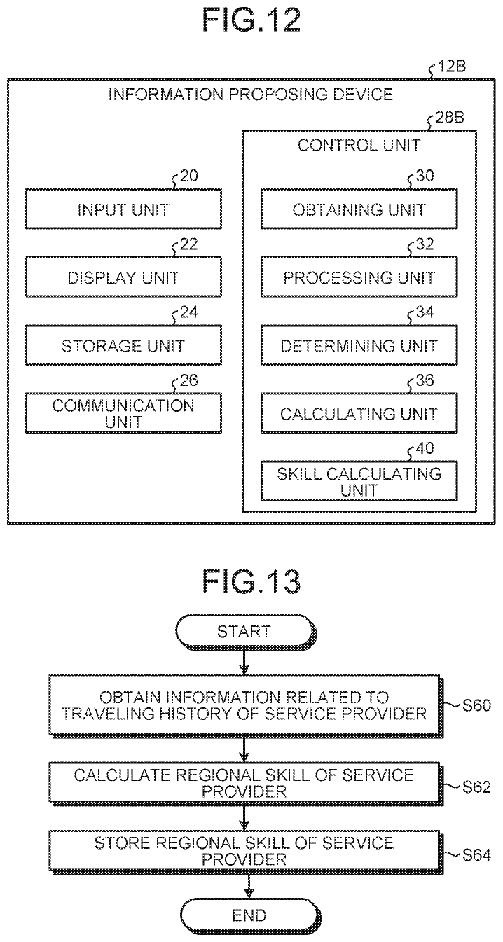

An example of a configuration of an information proposing device according to a third embodiment will be described using FIG. 12. FIG. 12 is a block diagram illustrating the example of the configuration of the information proposing device according to the third embodiment.

As illustrated in FIG. 12, an information proposing device 12B is different from the information proposing device 12 illustrated in FIG. 2 in that the information proposing device 12B includes a skill calculating unit 40. The information proposing device 12B is communicably connected to a navigation device installed in a vehicle of a service provider, via the communication unit 26, for example. In a case where the navigation device is implemented by a smartphone of the service provider, the information proposing device 12B may be communicably connected to the smartphone of the service provider.

In this third embodiment, the obtaining unit 30 obtains information related to a traveling history of the vehicle of the service provider. For example, the obtaining unit 30 obtains the information related to the traveling history from the navigation device installed in the vehicle of the service provider via the communication unit 26. The traveling history may include information related to the number of times travelled in a predetermined time period, the time period travelled, and the traveling frequency. The predetermined time period may be freely changed. The traveling history may include information related to the number of times a stopover has been made, the stopover frequency, and the stopover time period, at a specific area or facility. Information included in the traveling history is not limited to these pieces of information and may include any other pieces of information.

The skill calculating unit 40 calculates various skills of a service provider. For example, the skill calculating unit 40 calculates regional skills of a service provider on the basis of information related to a traveling history obtained by the obtaining unit 30. The regional skills may include knowledge of areas and knowledge of facilities.

In this third embodiment, the determining unit 34 performs matching processing between service providers and a tourist, on the basis of the regional skills of the service providers calculated by the skill calculating unit 40. That is, in this third embodiment, condition information may include information related to a regional skill. The condition information may include preference information on history and food or information related to a region, such as a desired waypoint to stop over.

### Processing Details

A process of calculating a regional skill of a service provider according to the third embodiment will be described using FIG. 13. FIG. 13 is a flowchart illustrating an example of a flow of the process of calculating a regional skill of a service provider, according to the third embodiment.

A control unit 28B obtains information related to a traveling history of a service provider (Step S60). Specifically, the obtaining unit 30 obtains the information related to the traveling history, from a navigation device of the service provider. The flow then proceeds to Step S62.

The control unit 28B calculates a regional skill of the service provider (Step S62). Specifically, the skill calculating unit 40 calculates a regional skill of the service provider on the basis of the information related to the traveling history obtained by the obtaining unit 30.

The skill calculating unit 40 calculates the service provider's knowledge of each area, on the basis of information related to the number of times travelled, the time period travelled, and the traveling frequency, the information being included in the information related to the traveling history, for example. The larger or longer the number of times travelled in an area, the time period travelled in the area, and the frequency of travel to the area, the higher the skill calculated for that area by the skill calculating unit 40, for example. The regional skill may be calculated using a point system, as 90 points or 50 points, for example. In this case, the higher the point of an area, the higher the regional skill of the service provider.

The skill calculating unit 40 calculates knowledge for each facility on the basis of information on the number of times a stopover has been made, the stopover frequency, and the stopover time period, at a facility, the information being included in the information related to the traveling history, for example. To distinguish a stopover from passage, a stay for a predetermined time period or more may be defined as a stopover. The larger or longer the number of times a stopover has been made, the stopover frequency, and the stopover time period at a facility, the higher that regional skill calculated for that facility by the skill calculating unit 40, for example.

The skill calculating unit 40 may assign an attribute to a facility according to the type of the facility. The skill calculating unit 40 may calculate a regional skill for each attribute. For example, it is assumed herein that the attributes of Facility A are history and food, the attribute of Facility B is history, and the attribute of Facility C is food. In this case, the skill calculating unit 40 calculates a regional skill for history on the basis of the number of times a stopover has been made at Facility A and the number of times a stopover has been made at Facility B, for example. The skill calculating unit 40 calculates a regional skill for food on the basis of the number of times a stopover has been made at Facility B and the number of times a stopover has been made at Facility C, for example. The skill calculating unit 40 may weight points according to facilities.

The skill calculating unit 40 may change between a regional skill calculating method based on an everyday traveling history of a service provider and a regional skill calculating method based on a traveling history for guidance to tourists, for example. The skill calculating unit 40 may make the point for a regional skill based on the traveling history for guidance to tourists higher than the point for a regional skill based on the everyday traveling history, for example.

The control unit 28B stores the regional skill of the service provider (Step S64). Specifically, the skill calculating unit 40 stores the regional skill calculated, in association with the service provider, into the storage unit 24. The process of FIG. 11 is then ended.

As described above, in the third embodiment, a regional skill of a service provider is calculated on the basis of a skill of the service provider. In the third embodiment, the calculated regional skill of the service provider is stored in a storage unit. The third embodiment thereby enables appropriate matching processing between service providers and a tourist in consideration of regional skills of the service providers, for example.

### Fourth Embodiment

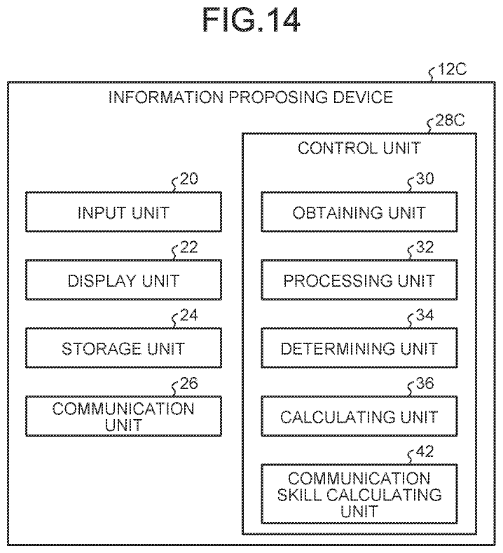

An example of a configuration of an information proposing device according to a fourth embodiment will be described using FIG. 14. FIG. 14 is a block diagram illustrating the example of the configuration of the information proposing device according to the fourth embodiment.

As illustrated in FIG. 14, an information proposing device 12C is different from the information proposing device 12 illustrated in FIG. 2 in that the information proposing device 12C has a control unit 20C that includes a communication skill calculating unit 42. The information proposing device 12C is communicably connected to a navigation device installed in a vehicle of a service provider via the communication unit 26, for example. In this fourth embodiment, the navigation device has a function of picking up voice in the vehicle. In a case where the navigation device is implemented by a smartphone of the service provider, the information proposing device 12C may be communicably connected to the smartphone of the service provider.

In this fourth embodiment, the obtaining unit 30 obtains information related to a traveling history of the vehicle of the service provider. For example, the obtaining unit 30 obtains the information related to the traveling history from the navigation device installed in the vehicle of the service provider, via the communication unit 26. The traveling history may include information related to the number of times travelled in a predetermined time period, the time period travelled, and the traveling frequency. The predetermined time period may be freely changed. The traveling history may include information related to the number of times a stopover has been made, the stopover frequency, and the stopover time period, at a specific area or facility. Information included in the traveling history is not limited to these pieces of information and may include any other pieces of information. For example, the obtaining unit 30 obtains voice information related to voice in the vehicle, from the navigation device installed in the vehicle of the service provider, via the communication unit 26.

The communication skill calculating unit 42 calculates a communication skill of the service provider. For example, the communication skill calculating unit 42 calculates a communication skill of the service provider on the basis of the information related to the traveling history obtained by the obtaining unit 30. For example, the communication skill calculating unit 42 calculates a communication skill of the service provider on the basis of the voice information obtained by the obtaining unit 30. The communication skill calculating unit 42 calculates a communication skill of the service provider on the basis of assessment by the service provider and tourists of services provided in the past, for example. The communication skill calculating unit 42 may correct the communication skill calculated on the basis of the assessment by the service provider herself/himself, on the basis of assessment by another person, such as a tourist, for example.

In this fourth embodiment, the determining unit 34 performs matching processing between service providers and a tourist, on the basis of communication skills of the service providers calculated by the communication skill calculating unit 42. That is, in this fourth embodiment, condition information may include information related to a communication skill.

### Processing Details

A process of calculating a communication skill of a service provider according to the fourth embodiment will be described using FIG. 13. FIG. 13 is a flowchart illustrating an example of a flow of the process of calculating a communication skill of a service provider, according to the fourth embodiment.

A control unit 28C obtains information on at least one of a traveling history, voice information, self-assessment, and assessment by another person, for a service provider (Step S70). Specifically, the obtaining unit 30 obtains information related to a traveling history and information related to voice of conversation between the service provider and tourists, for example, from a navigation device of the service provider. For example, the obtaining unit 30 obtains information related to self-assessment of a communication skill of the service provider from a service provider terminal 14, for example. The obtaining unit 30 obtains assessment of the service provider by tourists as assessment by another person, from user terminals 16, for example.

The control unit 28C calculates a communication skill of the service provider (Step S72). Specifically, the communication skill calculating unit 42 calculates a communication skill of the service provider on the basis of at least one of the information related to the traveling history, the voice information, the information related to self-assessment, and the information related to assessment by another person, which have been obtained by the obtaining unit 30.

The communication skill calculating unit 42 calculates a communication skill on the basis of a stopover time period at a facility, the stopover time period being included in the information related to the traveling history, for example. The communication skill calculating unit 42 calculates a communication skill by supposing that the service provider and the tourists are communicating with each other during the stopover time period at a facility, for example. The longer the stopover time period at a facility is, the higher the communication skill calculated by the communication skill calculating unit 42 may be.

The communication skill calculating unit 42 may calculate a communication skill of a service provider on the basis of voice information, for example. For example, the communication skill calculating unit 42 may calculate a communication skill of a service provider on the basis of a time period in which the service provider is speaking and a time period in which a tourist is speaking, for example. The communication skill calculating unit 42 may calculate a communication skill of a service provider according to the volume of voice of a customer, for example. For example, the larger the volume of voice of a tourist, the higher the service provider's communication skill calculated by the communication skill calculating unit 42.

The communication skill calculating unit 42 may calculate a communication skill of a service provider on the basis of information related to self-assessment and information related to assessment by another person. For example, the communication skill calculating unit 42 may give a score on a five-point scale, “1”, “2”, “3”, “4”, or “5”, to each of self-assessment and assessment by another person. In this case, “5” is the point for the highest communication skill and “1” is the point for the lowest communication skill.

The communication skill calculating unit 42 may correct a communication skill of a service provider on the basis of information related to self-assessment and information related to assessment by another person. For example, it is assumed that the point for a communication skill from self-assessment is “5” and the point for the communication skill from assessment by another person is “2”, these points having been obtained by the obtaining unit 30. In this case, the communication skill calculating unit 42 may correct the point for the communication skill from the self-assessment negatively. The point related to self-assessment and the point related to assessment by another person may be said to be subjective points by the service provider and the tourist, respectively. Therefore, the communication skill calculating unit 42 may correct the points for the communication skill such that the points have more objectivity.

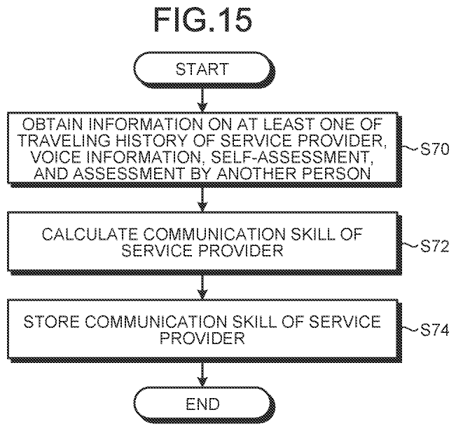

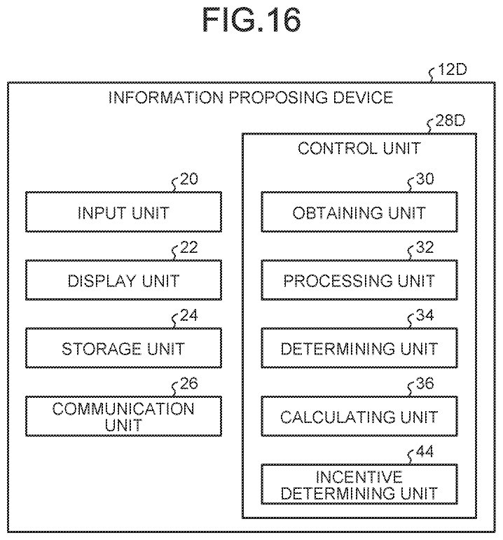

The control unit 28C stores the communication skill of the service provider (Step S74). Specifically, the communication skill calculating unit 42 stores the communication skill calculated, in association with the service provider, into the storage unit 24. The process of FIG. 15 is then ended.

As described above, in this fourth embodiment, a skill of a service provider is calculated on the basis of a communication skill of the service provider. In the fourth embodiment, the calculated communication skill of the service provider is stored in a storage unit. The fourth embodiment thereby enables appropriate matching processing between service providers and a tourist in consideration of communication skills of the service providers.

### Fifth Embodiment

An example of a configuration of an information proposing device according to a fifth embodiment will be described using FIG. 14. FIG. 14 is a block diagram illustrating the example of the configuration of the information proposing device according to the fifth embodiment.

As illustrated in FIG. 14, an information proposing device 12D is different from the information proposing device 12 illustrated in FIG. 2 in that the information proposing device 12D has a control unit 28D that includes an incentive determining unit 44. The information proposing device 12D is a device that determines incentive to be given to a service provider according to a service provided to a tourist, for example.

The incentive determining unit 44 determines incentive to be given to a service provider. For example, the incentive determining unit 44 determines incentive unique to a municipality according to the contribution to the municipality that the service provider belongs to, for example. For example, the incentive determining unit 44 determines, as incentive, a sales position in the municipality or a gift in return for a “benefit-your-locality” tax payment.

The incentive determining unit 44 calculates contribution of a service provider to a municipality. For example, the incentive determining unit 44 calculates the contribution on the basis of the time period travelled for guiding tourists. In this case, the longer the time period travelled, the higher the contribution calculated by the incentive determining unit 44. The incentive determining unit 44 calculates the contribution from the level of the communication skill and/or word-of-mouth information from tourists and levels of satisfaction of the tourists, for example. In this case, the better the result of assessment by the tourists, for example, the higher the contribution calculated by the incentive determining unit 44. For example, the incentive determining unit 44 calculates the contribution on the basis of the number of areas and facilities to which side trips were taken, and the time period of the side trips, for example. In this case, the larger the number of areas and facilities to which side trips were taken, or the longer the time period of the side trips, the higher the contribution calculated by the incentive determining unit 44, for example. In a case where side trips have been taken to areas and facilities that a municipality recommends tourists to visit, for example, the incentive determining unit 44 may add incentive according to the number of times a stopover has been made and the stopover time period.

As described above, in the fifth embodiment, contribution by a service provider to a municipality is calculated. In the fifth embodiment, incentive to be given to the service provider is determined according to the contribution. The fifth embodiment thereby enables incentive to be given appropriately to a service provider who has made a contribution to a municipality.

The present invention enables matching processing between service providers who provide services and tourists who receive services.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information proposing device, comprising:
an obtaining unit that obtains: service provider information including information related to a service that a service provider is able to provide; and condition information related to a condition for a service that a user desires to receive;
a processing unit that performs matching processing between the condition information and the service provider information; and
a calculating unit that calculates information related to the service provider and the service that are to be selected by the user, on the basis of a result of the matching processing.

2. The information proposing device according to claim 1, wherein
the service provider information includes information related to a skill of the service provider, and
the processing unit performs the matching processing between the condition information and the service provider information, on the basis of the information related to the skill of the service provider.

3. The information proposing device according to claim 1, wherein
the service provider information includes information related to depth of communication that is able to be provided by the service provider, and
the processing unit performs the matching processing between the condition information and the service provider information, on the basis of the information related to depth of communication that is able to be provided by the service provider.

4. The information proposing device according to claim 1, further comprising:
a plan generating unit that generates plural plans, on the basis of the result of the matching processing, wherein
the calculating unit visibly presents the plural plans generated by the plan generating unit.

5. The information proposing device according to claim 4, wherein the plan generating unit generates a plan according to the depth of communication that is able to be provided by the service provider.

6. The information proposing device according to claim 1, further comprising:
a skill calculating unit that calculates a skill of the service provider included in the service provider information, on the basis of a traveling history of the service provider.

7. An information proposing method, including:
a step of obtaining: service provider information including information related to a service that a service provider is able to provide; and condition information related to a condition for a service that a user desires to receive;
a step of performing matching processing between the condition information and the service provider information; and
a step of calculating information related to the service provider and the service that are to be selected by the user, on the basis of a result of the matching processing.
